(19) United States
(12) Patent Application Publication
(10) Pub. No.: US 2026/0230517 A1
(43) Pub. Date: Aug. 6, 2026

(54) REQUEST PROCESSING METHOD AND APPARATUS

(71) Applicant: CLOUD INTELLIGENCE ASSETS HOLDING (SINGAPORE) PRIVATE LIMITED, Singapore (SG)

(72) Inventor: Jiaji ZHU, Beijing (CN)

(21) Appl. No.: 19/156,809

(22) PCT Filed: Jan. 30, 2024
(86) PCT No.: PCT/CN2024/074784

§ 371 Date: Aug. 14, 2025

(30) Foreign Application Priority Data
Feb. 24, 2023 (CN) 202310199489.9

(51) Int. Cl. H04L 67/1004

(52) U.S. Cl. CPC H04L 67/1004

(57) ABSTRACT

Embodiments of this specification provide a request processing method and apparatus. The request processing method includes: receiving a to-be-sent request for a target service node; determining request statistical information and load information that correspond to the target service node; when it is determined, based on the request statistical information and the load information, that the to-be-sent request satisfies a defer-sending condition, determining a deferring policy corresponding to the to-be-sent request; and sending the to-be-sent request to the target service node according to the deferring policy. The request statistical information and the load information are determined on a side of a client, to determine whether the to-be-sent request satisfies the defer-sending condition. The to-be-sent request is sent to the target service node according to the deferring policy when the to-be-sent request satisfies the defer-sending condition.

### CROSS-REFERENCE TO RELATED APPLICATION

This application is a National Stage of International Application No. PCT/CN2024/074784, filed on Jan. 30, 2024, which claims priority to Chinese Patent Application No. 202310199489.9, entitled “REQUEST PROCESSING METHOD AND APPARATUS”, and filed with the China National Intellectual Property Administration on Feb. 24, 2023. These applications are incorporated herein by reference in their entireties.

### TECHNICAL FIELD

Embodiments of this specification relate to the field of distributed storage system technologies, and in particular, to a request processing method. One or more embodiments of this specification also relate to a request processing apparatus, a computing device, and a computer-readable storage medium.

### BACKGROUND

With the rapid development of Internet technologies, storage systems based on distributed architectures are widely used. A process of processing a request for accessing a distributed storage system is that a client sends the request to a server, and the server receives and processes the request, and returns a response result to the client. The distributed storage system adopts a typical client-server model, namely storage-compute separation. In this architecture, services of a plurality of computing clusters usually access a specific storage cluster intensively. As a result, overload access of a storage service node due to an excessive processing pressure may be caused. Consequently, the storage service node does not respond or crashes, thereby failing to serve a client normally. Therefore, how to reduce a processing load of the storage service node and ensure working stability of the node is a problem that needs to be urgently resolved currently.

### SUMMARY

In view of this, embodiments of this specification provide a request processing method. One or more embodiments of this specification also relate to a request processing apparatus, a request processing system, a computing device, a computer-readable storage medium, and a computer program, to resolve technical defects in existing technologies.

According to a first aspect of the embodiments of this specification, a request processing method is provided. The method is applied to a target client and includes:
receiving a to-be-sent request for a target service node;
determining request statistical information and load information that correspond to the target service node;
when it is determined, based on the request statistical information and the load information, that the to-be-sent request satisfies a defer-sending condition, determining a deferring policy corresponding to the to-be-sent request; and
sending the to-be-sent request to the target service node according to the deferring policy.

According to a second aspect of the embodiments of this specification, a request processing apparatus is provided. The apparatus is used in a target client and includes:
a receiving apparatus, configured to receive a to-be-sent request for a target service node;
a first determining apparatus, configured to determine request statistical information and load information that correspond to the target service node;
a second determining apparatus, configured to: when it is determined, based on the request statistical information and the load information, that the to-be-sent request satisfies a defer-sending condition, determine a deferring policy corresponding to the to-be-sent request; and
a sending apparatus, configured to send the to-be-sent request to the target service node according to the deferring policy.

According to a third aspect of the embodiments of this specification, a request processing system is provided. The system includes a service node and a client.

The client is configured to store request sending executable instructions. When the request sending executable instructions are executed by the client, steps of the request processing method are implemented, to enable interaction between the client and the service node.

According to a fourth aspect of the embodiments of this specification, a computing device is provided, including a memory, a processor, and computer instructions stored in the memory and executable in the processor. The processor, when executing the computer instructions, implements steps of the request processing method.

According to a fifth aspect of the embodiments of this specification, a computer-readable storage medium is provided, storing computer-executable instructions. When the computer-executable instructions are executed by a processor, steps of the request processing method are implemented.

According to a sixth aspect of the embodiments of this specification, a computer program is provided. When the computer program is run on a computer, the computer is enabled to perform steps of the request processing method.

The request processing method provided in this specification is applied to the client, and includes: receiving the to-be-sent request for the target service node; determining the request statistical information and the load information that correspond to the target service node; when it is determined, based on the request statistical information and the load information, that the to-be-sent request satisfies the defer-sending condition, determining the deferring policy corresponding to the to-be-sent request; and sending the to-be-sent request to the target service node according to the deferring policy.

In an embodiment of this specification, whether the to-be-sent request satisfies the defer-sending condition is determined by determining, on a side of the client, the request statistical information and the load information that correspond to the target service node. When the to-be-sent request satisfies the defer-sending condition, the deferring policy corresponding to the to-be-sent request is determined, and the to-be-sent request is sent to the target service node according to the deferring policy. The client actively defers sending the request to the service node to prevent overload access at the service node, thus ensuring working stability of the service node. Therefore, the service node can respond to an effective request more effectively, thereby improving working efficiency of the service node.

### BRIEF DESCRIPTION OF DRAWINGS

FIG. 1 is a schematic diagram of a request processing method according to an embodiment of this specification.

FIG. 2 is a flowchart of a request processing method according to an embodiment of this specification.

FIG. 3 is a flowchart of a processing process of a request processing method according to an embodiment of this specification.

FIG. 4 is a schematic structural diagram of a request processing apparatus according to an embodiment of this specification.

FIG. 5 is a structural block diagram of a computing device according to an embodiment of this specification.

### DESCRIPTION OF EMBODIMENTS

In the following descriptions, many specific details are described to fully understand this specification. However, this specification can be implemented in many other manners different from those described herein, and a person skilled in the art may perform similar extension without violating connotations of this specification. Therefore, this specification is not limited to specific implementations disclosed below.

Terms used in one or more embodiments of this specification are merely used to describe specific embodiments but are not intended to limit one or more embodiments of this specification. “A”, “the”, and “this” in a singular form used in one or more embodiments of this specification and the appended claims are also intended to include a plural form, unless other meanings are clearly indicated in the context. It should be further understood that the term “and/or” used in one or more embodiments of this specification indicates and includes any or all possible combinations of one or more associated listed items.

It should be understood that, although the terms “first”, “second”, and the like may be used to describe various information in one or more embodiments of this specification, such information should not be limited to these terms. These terms are merely used to distinguish between information of the same type. For example, without departing from the scope of one or more embodiments of this specification, “first” may also be referred to as “second”. Similarly, “second” may also be referred to as “first”. Depending on the context, for example, the word “if” used herein may be interpreted as “while” or “when” or “in response to determination”.

First, nouns and terms involved in one or more embodiments of this specification are explained.

RPC: Remote procedure call corresponds to local call. “Remote” refers to that network communication is required, and may be understood as calling a method in a remote device.

Storage-compute separation: The storage-compute separation is a distributed architecture framework that pools computing resources and storage resources through independent computing clusters and storage clusters. An advantage is that each resource is fully used, thus allowing for flexible expansion of computing and storage. The storage-compute separation is more flexible, and better conforms to a characteristic of cloud computing.

In a storage-compute separation architecture, to prevent server overload, the following common coping policies are included:

Degradation result provisioning: A client enters degradation processing after failing to receive a request response, for example, no longer performs data access, or sends a request to another data source for data access. However, it is usually difficult to degrade a storage service.

A service node actively rejects a request under an overload condition: In the overload condition, a server end actively rejects a request sent by a client. This is a common overload design. However, in an extreme scenario, for example, when a large quantity of clients send requests at high frequencies, overload determination and active rejection of the service node also consume a large quantity of processing resources such as a processor, an internal memory, and a network of the service node. Consequently, a normal serving capability and a recovery speed of the service node are affected.

Request resending: Exponential backoff and retry are performed after a client expires or fails. This method can quickly reduce load of a service node, but requires modification of service code of the client and assurance of correctness. Many service layers lack robust and correct retry policies, and service load is also increased.

A client sets a request limit: A client request QPS (Queries Per Second) limit is set. A disadvantage is that it is difficult for a service layer to predict a data value of the limit, flexibility is not high, and actual application is inconvenient.

Based on this, in this specification, a request processing method is provided. The method is used to determine, on a side of a client, request statistical information and load information that correspond to a target service node, to determine whether a to-be-sent request satisfies a defer-sending condition. When the to-be-sent request satisfies the defer-sending condition, the client determines a deferring policy corresponding to the to-be-sent request, and sends the to-be-sent request to the target service node according to the deferring policy. The client actively defers sending the request to the service node to prevent overload access at the service node, thus ensuring working stability of the service node. Therefore, the service node can respond to an effective request more effectively, thereby improving working efficiency of the service node. Overload access at the service node is avoided on the side of the client, a load pressure of the service node is reduced, and processing efficiency of the service node is improved. This specification also relates to a request processing apparatus, a request processing system, a computing device, a computer-readable storage medium, and a computer program, which are described in detail one by one in the following embodiments.

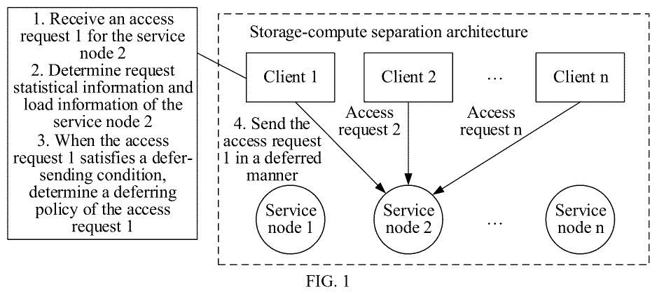

FIG. 1 is a schematic diagram of a request processing method according to an embodiment of this specification. FIG. 1 includes a storage-compute separation architecture. The architecture includes a plurality of clients, namely compute nodes, and a plurality of storage clusters, namely service nodes. The client may access the service node by using an SDK. When the plurality of clients simultaneously access a same service node, as shown in FIG. 1, the plurality of clients simultaneously access a service node 2, because a processing capability of the service node 2 is limited, according to a default overload protection mechanism of the service node 2, a request exceeding a preset processing threshold for the quantity of to-be-processed requests is discarded, and a response failure message is returned to a corresponding client. However, to process a request more quickly, the client sets a very short cyclic retry duration, and resends the request that failed to get a response to the service node. As a result, the service node further needs to consume a resource to process an invalid request, and processing of other normal services on the service node is consequently affected. According to a request processing method provided in an embodiment of this specification, when a client is to send an access request to a service node, the client determines request statistical information and load information that correspond to the service node; whether the sending of the access request needs to be sent in a deferred manner is determined based on the request statistical information and the load information, and when the access request satisfies a defer-sending condition, the client sends the request according to a corresponding deferring policy, so as to relieve a load pressure of the service node. Therefore, not only the service node can be enabled to normally process other services, but also it is ensured that the access request can be processed by the service node as soon as possible, so that efficiency of processing the request from the client is improved, and better use experience is brought to a user. According to the request processing method provided in this specification, whether the to-be-sent request satisfies the defer-sending condition is determined by determining, on a side of the client, the request statistical information and the load information that correspond to the target service node. When the to-be-sent request satisfies the defer-sending condition, the deferring policy corresponding to the to-be-sent request is determined, and the to-be-sent request is sent to the target service node according to the deferring policy. The client actively defers sending the request to the service node to prevent overload access at the service node, thus ensuring working stability of the service node. Therefore, the service node can respond to an effective request more effectively, thereby improving working efficiency of the service node.

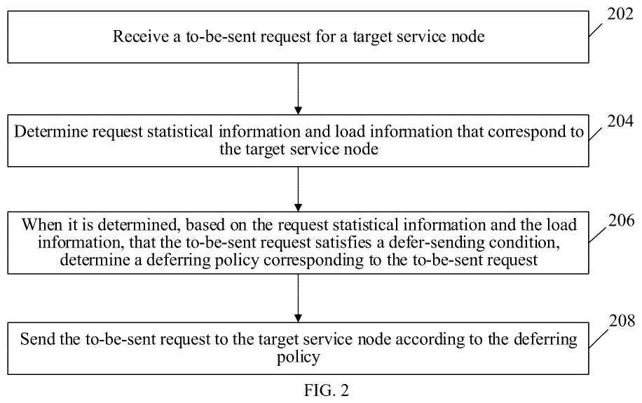

FIG. 2 is a flowchart of a request processing method according to an embodiment of this specification. The method is applied to a target client, and includes step 202 to step 208.

Step 202: receive a to-be-sent request for a target service node.

The to-be-sent request for the target service node may be understood as a request that needs to be sent to the target service node. The to-be-sent request may be a request of the client for accessing a resource stored in the target service node. For example, if an application in the client needs to invoke a resource in the target service node, a resource invoking request is sent to the target service node based on the client, and the resource invoking request is the to-be-sent request.

During actual application, in a storage-compute separation architecture, after the client sends the to-be-sent request to the target service node, the target service node accepts the request and starts to process the request. After completing the processing of the request, the target service node returns response information corresponding to the request to the client. The client sends the returned response information to an item application corresponding to the request.

In a specific embodiment of this specification, the client receives a resource download request of the item application for the target service node, uses the resource download request as the to-be-sent request, and subsequently sends the to-be-sent request to the corresponding target service node.

Step 204: determine request statistical information and load information that correspond to the target service node.

The request statistical information includes information such as a quantity of request sending times, a quantity of request failure times, and a quantity of request success times. Because the client needs to send the to-be-sent request to the target service node, only the request statistical information corresponding to the target service node needs to be determined. The request statistical information may be a quantity of times for which the client sends requests to the target service node and a quantity of times for which the target service node successfully responds or a quantity of times for which the target service node fails to respond within a preset period. The load information may be understood as a latest request processing QPS and a queue depth QD of the target service node. The request processing QPS is a quantity of times for which the target service node successfully responds to processing requests within a period (which is 1 second by default). The queue depth QD is a quantity of to-be-processed requests in a current request queue of the target service node.

During actual application, the side of the client records request statistical information and load information that correspond to each service node, and updates the request statistical information and the load information in real time, thereby achieving timeliness of sending the request in the deferred manner. After determining that the to-be-sent request needs to be sent to the target service node, the client determines the request statistical information and the load information that correspond to the target service node, and subsequently determines, based on the request statistical information and the load information, whether the current to-be-sent request needs to be sent in the deferred manner, thereby reducing a load pressure of the target service node, avoiding an overload condition of the target service node, and ensuring working stability of the target service node.

In a specific embodiment of this specification, the client determines the request statistical information and the load information that correspond to the target service node. The request statistical information includes that the client sends ten requests to the target service node within one minute, where seven requests succeed and three requests fail. The load information includes that the request processing QPS of the target service node is 5, and the queue depth QD is 10.

Further, to avoid the subsequent overload condition of the target service node caused by an error in determining deferring of the to-be-sent request due to an exception of the request statistical information, correctness of the request statistical information needs to be ensured. Specifically, the determination of the request statistical information that corresponds to the target service node includes: determining a historical sending request that is for the target service node within a preset time period and historical response information corresponding to the historical sending request; and determining, based on the historical sending request and the historical response information, the request statistical information that corresponds to the target service node.

The preset time period may be understood as a period that is set in advance and in which a quantity of requests sent by the client to the target service node is counted. The preset time period may be set based on an actual condition. For example, a quantity of requests sent by the client to the target service node within last one minute is counted. The historical response information may be understood as a quantity of request success times and/or a quantity of request failure times for the requests sent by the client to the target service node within the preset time period. Because a processing capability of the target service node is limited, when there are excessive to-be-processed requests in a queue of the target service node, an overload protection mechanism of the target service node is triggered, and the target service node directly returns response failure information for a request that is just received. In this case, the client counts the quantity of request failure times once.

During actual application, a quantity of times for which the client sends requests to the target service node within the preset time period and response information corresponding to each request, that is, information about whether each request succeeds, may be determined based on the historical sending requests and the historical response information. The request statistical information corresponding to the target service node may be determined by collecting the historical sending requests and the historical response information.

In a specific embodiment of this specification, the client determines historical requests sent to the target service node within the preset time period and historical response information corresponding to each historical request, and determines, based on the historical sending requests and the historical response information, the request statistical information corresponding to the target service node.

Based on this, the client determines the historical sending request(s) and the historical response information of the target service node, so that the request statistical information corresponding to the target service node can be accurately collected, thereby facilitating subsequent determination of whether the to-be-sent request needs to be sent in the deferred manner based on the request statistical information.

Further, to avoid the overload condition of the target service node, the client needs to clearly learn a load condition of the target service node. The load condition of the target service node may be returned to the client by the target service node through response information corresponding to the request. Specifically, the determination of the load information that corresponds to the target service node includes: receiving historical reply information of the target service node for the historical sending request; and determining, based on the historical reply information, the load information that corresponds to the target service node.

The historical sending request is a request previously sent by the client to the target service node. The historical reply information may be understood as response information returned by the target service node to the client for the historical sending request. The historical reply information may be response success information or response failure information. The target service node adds the load information to the historical reply information. Therefore, the client may determine, from the historical reply information, the load information corresponding to the target service node.

During actual application, when returning an RPC Response reply, the service node automatically adds the load information QPS and QD to reply information, so that when receiving the reply information, the client can acquire the current load information of the service node from the reply information.

In a specific embodiment of this specification, the client receives the historical reply information returned by the target service node for the historical sending request, and determines, based on the load information carried in the historical reply information, the load information corresponding to the target service node.

Based on this, the client may acquire, based on the historical reply information returned by the target service node, the load information of the target service node from the historical reply information, to more clearly learn the current load condition of the target service node, thereby facilitating subsequent accurate determination of whether the to-be-sent request needs to be sent in the deferred manner.

Further, to avoid the overload condition of the target service node, the client needs to clearly learn a load condition of the target service node. A heartbeat server may monitor the load condition of the service node, and sends the load information to the client via the heartbeat service. Specifically, the determination of the load information that corresponds to the target service node includes: receiving heartbeat information sent by a heartbeat server for the target service node, where the heartbeat server is configured to monitor load information corresponding to each service node; and determining, based on the heartbeat information, the load information that corresponds to the target service node.

The heartbeat server may be understood as a server managing service nodes. The heartbeat server may periodically collect load information of all service nodes, and regularly send the collected load information to all clients via a heartbeat service, so that the clients can acquire the load information of all the service nodes.

During actual application, the service node may periodically aggregate the load information to the heartbeat server. After receiving the load information sent by the service node, the heartbeat server generates the heartbeat information based on the load information, and sends the heartbeat information to the client. After receiving the heartbeat information, the client may acquire, from the heartbeat information, the load information corresponding to the target service node. During specific implementations, to avoid an excessively large data volume of the heartbeat information sent by the heartbeat server, the client may further send a load information acquiring request to the heartbeat server. After receiving the load information acquiring request, the heartbeat server returns the load information of the corresponding target service node to the client based on the request, thereby reducing the data volume of the heartbeat information that needs to be sent, and improving processing efficiency.

In a specific embodiment of this specification, the client receives the heartbeat information sent by the heartbeat server for the target service node. After receiving the heartbeat information, the client determines, based on the load information carried in the heartbeat information, the load information corresponding to the target service node.

Based on this, the client may acquire, based on the heartbeat information returned by the heartbeat server, the load information of the target service node from the heartbeat information, to more clearly learn the current load condition of the target service node, thereby facilitating subsequent accurate determination of whether the to-be-sent request needs to be sent in the deferred manner.

Step 206: when it is determined, based on the request statistical information and the load information, that the to-be-sent request satisfies a defer-sending condition, determine a deferring policy corresponding to the to-be-sent request.

The defer-sending condition may be understood as a determining condition for determining whether the request needs to be sent in the deferred manner. Whether the to-be-sent request satisfies the defer-sending condition can be determined based on the request statistical information and the load information. When the to-be-sent request satisfies the defer-sending condition, the deferring policy corresponding to the to-be-sent request is determined. When the to-be-sent request does not satisfy the defer-sending condition, the to-be-sent request is directly sent to the target service node.

During actual application, when it is determined, based on the request statistical information and the load information, that the to-be-sent request satisfies the defer-sending condition, the deferring policy corresponding to the to-be-sent request may be determined. The deferring policy may be a time deferring policy or a priority degradation policy. The time deferring policy may be that the client sends the request after a deferring duration. The priority degradation policy may be that a priority of the to-be-sent request is lowered, and a request corresponding to another service node is processed first, that is, another request is sent to the other service node. The deferring policy may alternatively be that sending of the request is deferred in another manner. This is not specifically limited in this application herein.

In a specific embodiment of this specification, after determining the request statistical information and the load information, the client determines, based on the request statistical information and the load information, whether the to-be-sent request satisfies the defer-sending condition, and determines, when the to-be-sent request satisfies the defer-sending condition, the deferring policy corresponding to the to-be-sent request.

Based on this, whether the to-be-sent request needs to be sent is determined by combining the request statistical information from the side of the client and the load information from a side of the service node, so that the client can participate in the determination and take active actions for overload prevention. Through cooperation between the client and the service node, the client actively rejects sending the request or defers sending the request, to help the service node better complete overload protection and quick replying.

Further, because the request statistical information includes the historical sending request and the historical response information, to prevent the client from incorrectly determining a sending policy of the to-be-sent request, a preset deferring threshold may be determined based on the load information, and compared with the request statistical information, to more accurately determine whether the to-be-sent request needs to be sent in the deferred manner. Specifically, the when it is determined, based on the request statistical information and the load information, that the to-be-sent request satisfies a defer-sending condition, determining a deferring policy corresponding to the to-be-sent request includes: calculating, based on a historical request quantity of historical sending requests and a historical failure quantity of the historical response information, a historical request failure rate of the target service node that is within a preset period; calculating, based on the load information, a preset deferring threshold corresponding to the to-be-sent request, where the preset deferring threshold includes a preset request quantity and a preset request failure rate; and when the historical request quantity is greater than the preset request quantity, and the historical request failure rate is greater than the preset request failure rate, determining that the to-be-sent request satisfies the defer-sending condition, and continuing to perform the step of determining the deferring policy corresponding to the to-be-sent request.

The historical request quantity may be understood as a quantity of times for which the historical sending requests were sent or a request quantity of the historical sending requests. For example, if the client sends ten requests to the target service node within last one minute, the historical request quantity is ten. The historical failure quantity may be understood as a quantity of request response failures in the historical response information. The historical response information may include request failure information. Therefore, a request failure quantity may be determined. For example, if the historical response information includes five successfully responded requests and five unsuccessfully responded requests, the historical failure quantity is five. The historical request failure rate of the target service node that is within the preset period may be calculated based on the historical request quantity and the historical failure quantity. The preset period is the same as the preset statistical period of historical sending requests. The historical request failure rate may be understood as a probability that the client sends a request to the target service node within the preset period and the request fails to be responded. For example, if the client sends ten requests to the target service node within one minute, and five requests fail to be responded, the historical request failure rate is 0.5. The preset deferring threshold may be understood as a threshold for determining whether a request needs to be sent in the deferred manner. The preset deferring threshold includes the preset request quantity and the preset request failure rate. The preset deferring threshold may be used as a warning threshold of overload of the target service node. During specific implementations, the preset deferring threshold may be calculated based on the load information of the service node. For example, if a value of the QPS plus a value of the QD of the service node is larger, it indicates that the current service node is in a busy state, and the preset deferring threshold may be properly decreased to more quickly suppress sending of a request. It should be noted that a manner of calculating the preset request quantity and the preset request failure rate that are in the preset deferring threshold may be determined based on an actual condition, provided that an association between the values of the preset request quantity and the preset request failure rate and the load information is ensured. The manner of calculating the preset request quantity and the preset request failure rate is not specifically limited in the present application.

During actual application, if the historical request quantity is greater than the preset request quantity, and the historical request failure rate is greater than the preset request failure rate, it indicates that the target service node is in an overload state currently, and the to-be-sent request needs to be sent in the deferred manner.

In a specific embodiment of this specification, if the client determines, based on the historical sending requests, that the historical request quantity is 10, and determines, based on the historical response information, that the historical failure quantity is 6, the client calculates the historical request failure rate as 0.6 based on the historical request quantity and the historical failure quantity. The client calculates the preset request quantity as 5 and the preset request failure rate as 0.5 based on the load information. The historical request quantity is compared with the preset request quantity, and the historical request failure rate is compared with the preset request failure rate. If it is determined that the historical request quantity is greater than the preset request quantity, and the historical request failure rate is greater than the preset request failure rate, the client determines that the to-be-sent request satisfies the defer-sending condition in this case, and continues to determine the deferring policy corresponding to the to-be-sent request. Subsequently, the client sends the to-be-sent request in the deferred manner according to the deferring policy.

In conclusion, the historical request quantity and the historical request failure rate are determined based on the request statistical information, the preset request quantity and the preset request failure rate are calculated based on the load information, so that the client and the service node cooperate with each other. Whether the to-be-sent request satisfies the defer-sending condition is accurately determined by comparing the historical request quantity and the preset request quantity, and comparing the historical request failure rate and the preset request failure rate, thereby preventing the service node from being overloaded, and ensuring normal working of the service node.

Step 208: send the to-be-sent request to the target service node according to the deferring policy.

When it is determined that the to-be-sent request needs to be sent in the deferred manner, the to-be-sent request needs to be sent to the target service node according to the determined deferring policy.

During actual application, if the client determines that the target service node is currently in the busy state, all requests subsequently sent by the client to the target service node within a period of time are sent according to the deferring policy, thereby preventing the service node from being overloaded and ensuring the working stability of the service node.

In a specific embodiment of this specification, the client sends the to-be-sent request to the target service node according to the determined deferring policy.

Based on this, whether the to-be-sent request satisfies the defer-sending condition is determined by determining, on the side of the client, the request statistical information and the load information that correspond to the target service node. When the to-be-sent request satisfies the defer-sending condition, the deferring policy corresponding to the to-be-sent request is determined, and the to-be-sent request is sent to the target service node according to the deferring policy. The client actively defers sending the request to the service node to prevent overload access at the service node, thus ensuring working stability of the service node. Therefore, the service node can respond to an effective request more effectively, thereby improving working efficiency of the service node.

Further, to prevent a situation where the client's sending of the to-be-sent request to the target service node could result in the overload condition of the target service node, which consequently prevents the client from normally obtaining a processing result corresponding to the request, the to-be-sent request may be sent in the deferred manner according to the deferring policy. Specifically, when the deferring policy is a time deferring policy, the sending the to-be-sent request to the target service node according to the deferring policy includes: determining a historical request failure rate based on the time deferring policy, and calculating a deferring duration based on the historical request failure rate; and sending the to-be-sent request to the target service node based on the deferring duration.

When the deferring policy is determined as the time deferring policy, the to-be-sent request is sent to the target service node according to the time deferring policy. The time deferring policy may be understood as that the client sends the to-be-sent request to the target service node after the deferring duration. If the target service node returns the response failure information, the client may send the to-be-sent request to the target service node again after the deferring duration, and automatically exit a request sending phase until the target service node returns the response success information or the client reaches a request processing duration.

During actual application, when the deferring policy is determined as the time deferring policy, the historical request failure rate needs to be determined based on the time deferring policy, and the deferring duration is calculated based on the historical request failure rate. A higher historical request failure rate indicates a longer deferring duration. It should be noted that a manner of calculating the deferring duration is not specifically limited in the present application, provided that it is determined that the manner of calculating the deferring duration is related to the historical request failure rate.

In a specific embodiment of this specification, the deferring policy is determined as the time deferring policy. If a current time point is T, the client sends all requests to the target service node in the deferred manner according to the time deferring policy before a time point T+t, determines the historical request failure rate f, calculates the deferring duration d based on the historical request failure rate f, and sends the to-be-sent request to the target service node in the deferred manner based on the deferring duration d.

Based on this, when the deferring policy is the time deferring policy, the deferring duration is calculated based on the historical request failure rate. Therefore, not only it is ensured that the client does not immediately send the to-be-sent request to the service node, thereby ensuring that the overload condition of the service node is avoided, but also the client is enabled to send the to-be-sent request to the service node in time after the deferring duration, so that the service node processes the to-be-sent request, thereby ensuring that the client can acquire, in time, a response result corresponding to the request.

Further, to prevent a situation that a plurality of clients send requests to the target service node based on the same deferring duration, leading to the target service node always being in the overload state, randomness may be introduced into the calculation of the deferring duration. Specifically, the calculation of the deferring duration based on the historical request failure rate includes: calculating an initial deferring duration based on the historical request failure rate; and determining a random duration corresponding to the to-be-sent request, and calculating the deferring duration based on the random duration and the initial deferring duration.

The initial deferring duration may be understood as a deferring duration calculated based on the historical request failure rate. The determined random duration corresponding to the to-be-sent request may be understood as a duration randomly added when the client calculates the deferring duration at this time. For example, if the initial deferring duration is calculated as 5 ms, and the random duration is determined as 1 ms, the deferring duration is calculated as 6 ms based on the random duration and the initial deferring duration.

During actual application, because a plurality of clients may send requests to the target service node in the deferred manner according to the time deferring policy, each client calculates its deferring duration and sends the request to the target service node based on the deferring duration. In this case, the overload condition of the target service node is also caused, and the target service node may always be not able to respond to the requests. As a result, each client cannot receive corresponding response success information. To avoid the foregoing resonance effect, when different clients calculate their deferring durations, randomness may be introduced. During specific implementations, the random duration corresponding to the to-be-sent request may be determined, and the deferring duration may be calculated according to a random calculation formula.

In a specific embodiment of this specification, a client A calculates the initial deferring duration as 5 ms based on the historical request failure rate, determines the random duration as 1 ms, and calculates the deferring duration as 6 ms based on the random duration and the initial deferring duration. A client B calculates the initial deferring duration as 5 ms based on the historical request failure rate, determines the random duration as 1 ms, and calculates the deferring duration as 4 ms based on the random duration and the initial deferring duration.

In conclusion, randomness is introduced into the process of calculating the deferring duration, so that different clients can obtain different deferring durations by using different operation methods, even if the different clients obtain the same initial deferring duration and random duration, to avoid the resonance effect, and reduce a possibility of the overload condition of the service node.

Further, when the client sends the to-be-sent request according to the time deferring policy, to prevent the client from sending another request to the target service node, the client needs to send all requests to the target service node in the deferred manner within a time deferring period. Specifically, the sending the to-be-sent request to the target service node based on the deferring duration includes: determining a time deferring period based on the time deferring policy, where the time deferring period is used to determine an execution period for executing the time deferring policy to send a global request for the target server; and sending the to-be-sent request to the target service node based on the deferring duration within the time deferring period.

The time deferring period may be understood as a period in which the client needs to send a request in the deferred manner. For example, if a time point at which the time deferring policy is triggered is T, the time deferring period may be determined as (T, T+t). Within the time deferring period, all requests sent by the client to the target service node are sent in the deferred manner based on the deferring duration, to ensure that the client does not immediately send the request to the target service node. The global requests may be understood as all requests subsequently sent by the client to the target service node. Within a preset deferring period, the client needs to execute the time deferring policy to send all the requests to the target service node in the deferred manner.

In a specific embodiment of this specification, the client determines the time deferring period based on the time deferring policy. Within the time deferring period, all the requests to be sent by the client to the target service node are sent in the deferred manner.

In conclusion, the time deferring period is determined, so that the client sends, within the time deferring period, all the global requests that need to be subsequently sent to the target service node in the deferred manner based on the deferring duration.

Further, to prevent a situation that the client cyclically sends a request to the service node based on the deferring duration because the service node is always in the busy state, and cannot acquire response information corresponding to the request, a request response duration may be set to exit a request sending cycle. Specifically, the method further includes: determining a request response duration corresponding to the to-be-sent request; and generating response failure information of the to-be-sent request when the deferring duration is longer than the request response duration.

The request response duration may be understood as a request sending end duration set by a user. When the duration for sending a request exceeds the request response duration, the client may directly generate the response failure information corresponding to the to-be-sent request, indicating that the target service node cannot normally respond to the to-be-sent request in this case. The client may directly generate the response failure information and feedback the response failure information to the user.

During actual application, after the user sets the request response duration, if the request has not been processed and responded to by the service node over the request response duration, the client may directly generate the response failure information corresponding to the request, to avoid a case that the request is always cyclically sent to the target service node, and ensure that the user can learn current processing status of the request in time.

In a specific embodiment of this specification, the to-be-sent request is a resource download request. After the client sends the resource download request to the target service node based on the deferring duration, the target service node always returns a response failure to the client. The client continues to send the resource download request to the target service node based on the deferring duration. When the deferring duration exceeds the remaining request response duration, the client directly generates response failure information to an application layer, so that the user learns a request state that a resource fails to be downloaded.

Based on this, the request response duration is set and compared with the deferring duration, so that the client can be prevented from being always in a cyclic state of sending the request in the deferred manner, to save processing resources of the client and the service node.

Further, after the to-be-sent request is successfully responded or unsuccessfully responded by the target service node, the client counts a target request quantity and a target failure quantity that correspond to the to-be-sent request, and updates the request statistical information, to facilitate the determination of the defer-sending condition for a subsequent request. Specifically, the method further includes: counting a target request quantity and a target failure quantity that correspond to the to-be-sent request; and updating the request statistical information based on the target request quantity and the target failure quantity.

The target request quantity may be understood as a quantity of sending times corresponding to the to-be-sent request, and the target failure quantity may be understood as a quantity of times for which the to-be-sent request fails to be responded. The target request quantity and the target failure quantity that correspond to the to-be-sent request are updated to the request statistical information, so that the client can perform the determination based on latest data when subsequently determining the defer-sending condition for a subsequent request, thereby ensuring data timeliness.

In a specific embodiment of this specification, the target request quantity and the target failure quantity that correspond to the to-be-sent request are counted, and the target request quantity and the target failure quantity are updated to the request statistical information. When subsequently determining the defer-sending condition for the subsequent request, the client can perform the determination based on the updated request statistical information.

The request processing method provided in this specification is applied to the target client, and includes: receiving the to-be-sent request for the target service node; determining the request statistical information and the load information that correspond to the target service node; when it is determined, based on the request statistical information and the load information, that the to-be-sent request satisfies the defer-sending condition, determining the deferring policy corresponding to the to-be-sent request; and sending the to-be-sent request to the target service node according to the deferring policy. Whether the to-be-sent request satisfies the defer-sending condition is determined by determining, on the side of the client, the request statistical information and the load information that correspond to the target service node. When the to-be-sent request satisfies the defer-sending condition, the deferring policy corresponding to the to-be-sent request is determined, and the to-be-sent request is sent to the target service node according to the deferring policy. The client actively defers sending the request to the service node to prevent overload access at the service node, thus ensuring working stability of the service node. Therefore, the service node can respond to an effective request more effectively, thereby improving working efficiency of the service node.

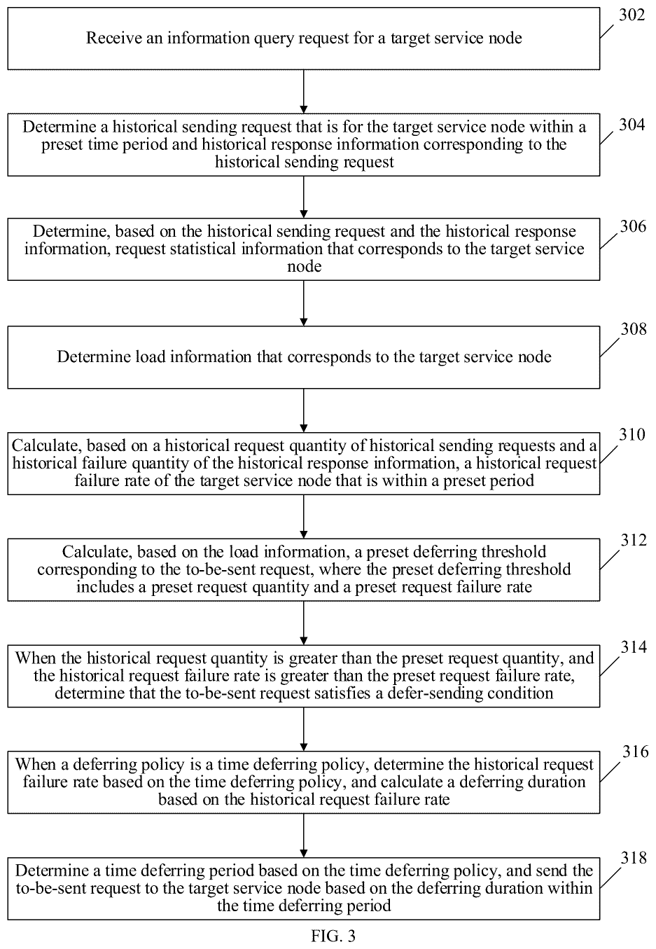

With reference to FIG. 3, the request processing method is further described below by using an example in which the request processing method provided in this specification is applied to information query. FIG. 3 is a flowchart of a processing process of a request processing method according to an embodiment of this specification. Specific steps include step 302 to step 318.

Step 302: receive an information query request for a target service node.

In an implementable manner, a client receives an information query request of an application layer for the target service node.

Step 304: determine a historical sending request that is for the target service node within a preset time period and historical response information corresponding to the historical sending request.

In an implementable manner, the client determines a historical sending request that is for the target service node within one minute and historical response information corresponding to the historical sending request.

Step 306: determine, based on the historical sending request and the historical response information, request statistical information that corresponds to the target service node.

In an implementable manner, the request statistical information that corresponds to the target service node is generated through combination based on the historical sending request sent by the client to the target service node within one minute and the historical response information.

Step 308: determine load information that corresponds to the target service node.

In an implementable manner, the client receives historical reply information returned by the target service node for the historical sending request, and determines, from the historical reply information, the load information that corresponds to the target service node.

In an implementable manner, the client receives heartbeat information sent by a heartbeat server for the target service node, and determines, from the heartbeat information, the load information that corresponds to the target service node.

Step 310: calculate, based on a historical request quantity of historical sending requests and a historical failure quantity of the historical response information, a historical request failure rate of the target service node that is within a preset period.

In an implementable manner, the client calculates, based on the historical request quantity of the historical sending requests and the historical failure quantity in the historical response information, the historical request failure rate corresponding to the target service node.

Step 312: calculate, based on the load information, a preset deferring threshold corresponding to the to-be-sent request, where the preset deferring threshold includes a preset request quantity and a preset request failure rate.

In an implementable manner, the client calculates the preset request quantity and the preset request failure rate based on the load information.

Step 314: when the historical request quantity is greater than the preset request quantity, and the historical request failure rate is greater than the preset request failure rate, determine that the to-be-sent request satisfies a defer-sending condition.

In an implementable manner, when the client determines that the historical request quantity is greater than the preset request quantity, and the historical request failure rate is greater than the preset request failure rate, it indicates that the to-be-sent request needs to be sent in a deferred manner.

Step 316: when a deferring policy is a time deferring policy, determine the historical request failure rate based on the time deferring policy, and calculate a deferring duration based on the historical request failure rate.

In an implementable manner, the client determines that the deferring policy is the time deferring policy, determines the historical request failure rate, and calculates the deferring duration based on the historical request failure rate.

In an implementable manner, when calculating the deferring duration based on the historical request failure rate, the client may first calculate an initial deferring duration based on the historical request failure rate, determine a random duration corresponding to the to-be-sent request, and calculate the deferring duration according to a random calculation method based on the initial deferring duration and the random duration.

Step 318: determine a time deferring period based on the time deferring policy, and send the to-be-sent request to the target service node based on the deferring duration within the time deferring period.

In an implementable manner, a current time point is determined as T, the time deferring period is determined as (T, T+t) based on the time deferring policy, and the to-be-sent request is sent to the target service node based on the deferring duration within the time deferring period.

In an implementable manner, when the deferring duration is longer than a remaining duration in the request response duration, that is, a timeout duration, resource download failure information corresponding to the request is directly generated, and the information is returned to the application layer.

The request processing method that is applied to resource download and that is provided in this specification is applied to the target client, and includes: receiving the information query request for the target service node; determining the historical sending request that is for the target service node within the preset time period and the historical response information corresponding to the historical sending request; determining, based on the historical sending request and the historical response information, the request statistical information that corresponds to the target service node; determining the load information that corresponds to the target service node; calculating, based on the historical request quantity of the historical sending requests and the historical failure quantity of the historical response information, the historical request failure rate of the target service node that is within the preset period; calculating, based on the load information, the preset deferring threshold corresponding to the to-be-sent request, where the preset deferring threshold includes the preset request quantity and the preset request failure rate; when the historical request quantity is greater than the preset request quantity, and the historical request failure rate is greater than the preset request failure rate, determining that the to-be-sent request satisfies the defer-sending condition; when the deferring policy is the time deferring policy, determining the historical request failure rate based on the time deferring policy, and calculating the deferring duration based on the historical request failure rate; and determining the time deferring period based on the time deferring policy, and sending the to-be-sent request to the target service node based on the deferring duration within the time deferring period. Whether the to-be-sent request satisfies the defer-sending condition is determined by determining, on the side of the client, the request statistical information and the load information that correspond to the target service node. When the to-be-sent request satisfies the defer-sending condition, the deferring policy corresponding to the to-be-sent request is determined, and the to-be-sent request is sent to the target service node according to the deferring policy. The client actively defers sending the request to the service node to prevent overload access at the service node, thus ensuring working stability of the service node. Therefore, the service node can respond to an effective request more effectively, thereby improving working efficiency of the service node.

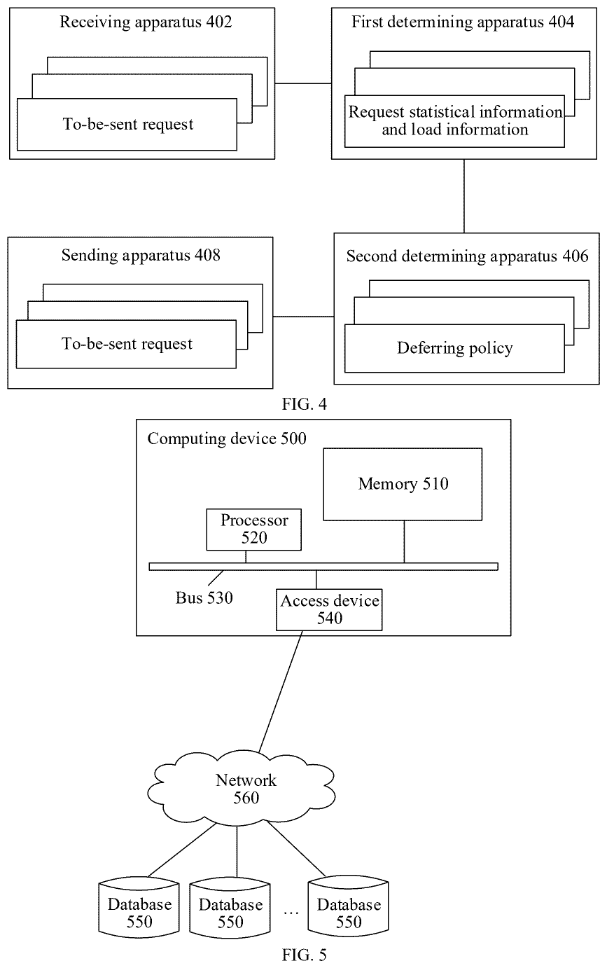

Corresponding to the foregoing method embodiments, this specification further provides an embodiment of a request processing apparatus. FIG. 4 is a schematic structural diagram of a request processing apparatus according to an embodiment of this specification. As shown in FIG. 4, the apparatus includes:
a receiving apparatus 402, configured to receive a to-be-sent request for a target service node;
a first determining apparatus 404, configured to determine request statistical information and load information that correspond to the target service node;
a second determining apparatus 406, configured to: when it is determined, based on the request statistical information and the load information, that the to-be-sent request satisfies a defer-sending condition, determine a deferring policy corresponding to the to-be-sent request; and
a sending apparatus 408, configured to send the to-be-sent request to the target service node according to the deferring policy.

In an implementation, the first determining apparatus 404 is further configured to determine a historical sending request that is for the target service node within a preset time period and historical response information corresponding to the historical sending request; and determine, based on the historical sending request and the historical response information, the request statistical information that corresponds to the target service node.

In an implementation, the first determining apparatus 404 is further configured to receive historical reply information of the target service node for the historical sending request; and determine, based on the historical reply information, the load information that corresponds to the target service node.

In an implementation, the first determining apparatus 404 is further configured to receive heartbeat information sent by a heartbeat server for the target service node, where the heartbeat server is configured to monitor load information corresponding to each service node; and determine, based on the heartbeat information, the load information that corresponds to the target service node.

In an implementation, the first determining apparatus 404 is further configured to calculate, based on a historical request quantity of historical sending requests and a historical failure quantity of the historical response information, a historical request failure rate of the target service node that is within a preset period; calculate, based on the load information, a preset deferring threshold corresponding to the to-be-sent request, where the preset deferring threshold includes a preset request quantity and a preset request failure rate; and when the historical request quantity is greater than the preset request quantity, and the historical request failure rate is greater than the preset request failure rate, determine that the to-be-sent request satisfies the defer-sending condition, and continue to perform the step of determining the deferring policy corresponding to the to-be-sent request.

In an implementation, when the deferring policy is a time deferring policy, the sending apparatus 408 is further configured to determine a historical request failure rate based on the time deferring policy, and calculate a deferring duration based on the historical request failure rate; and send the to-be-sent request to the target service node based on the deferring duration.

In an implementation, the sending apparatus 408 is further configured to calculate an initial deferring duration based on the historical request failure rate; and determine a random duration corresponding to the to-be-sent request, and calculate the deferring duration based on the random duration and the initial deferring duration.

In an implementation, the sending apparatus 408 is further configured to determine a time deferring period based on the time deferring policy, where the time deferring period is used to determine an execution period for executing the time deferring policy to send a global request for the target server; and send the to-be-sent request to the target service node based on the deferring duration within the time deferring period.

In an implementation, the apparatus further includes a generating module, configured to determine a request response duration corresponding to the to-be-sent request; and generate response failure information of the to-be-sent request when the deferring duration is longer than the request response duration.

In an implementation, the apparatus further includes an updating module, configured to count a target request quantity and a target failure quantity that correspond to the to-be-sent request; and update the request statistical information based on the target request quantity and the target failure quantity.

The request processing apparatus provided in this specification is used in the target client, and includes: the receiving apparatus, configured to receive the to-be-sent request for the target service node; the first determining apparatus, configured to determine the request statistical information and the load information that correspond to the target service node; the second determining apparatus, configured to: when it is determined, based on the request statistical information and the load information, that the to-be-sent request satisfies the defer-sending condition, determine the deferring policy corresponding to the to-be-sent request; and the sending apparatus, configured to send the to-be-sent request to the target service node according to the deferring policy. Whether the to-be-sent request satisfies the defer-sending condition is determined by determining, on the side of the client, the request statistical information and the load information that correspond to the target service node. When the to-be-sent request satisfies the defer-sending condition, the deferring policy corresponding to the to-be-sent request is determined, and the to-be-sent request is sent to the target service node according to the deferring policy. The client actively defers sending the request to the service node to prevent overload access at the service node, thus ensuring working stability of the service node. Therefore, the service node can respond to an effective request more effectively, thereby improving working efficiency of the service node.

The foregoing is a schematic solution of the request processing apparatus in this embodiment. It should be noted that the technical solutions of the request processing apparatus and the technical solutions of the foregoing request processing method belong to a same concept. For details that are not described in detail in the technical solutions of the request processing apparatus, reference may be made to the descriptions of the technical solutions of the foregoing request processing method.

FIG. 5 is a structural block diagram of a computing device 500 according to an embodiment of this specification. Components of the computing device 500 include, but are not limited to, a memory 510 and a processor 520. The processor 520 is connected to the memory 510 by using a bus 530, and a database 550 is configured to store data.

The computing device 500 further includes an access device 540, and the access device 540 enables the computing device 500 to communicate via one or more networks 560. Examples of these networks include a public switched telephone network (PSTN), a local area network (LAN), a wide area network (WAN), a personal area network (PAN), or a combination of communication networks such as the Internet. The access device 540 may include one or more of any type of wired or wireless network interfaces (for example, a network interface card (NIC)), such as an IEEE 802.11 wireless local area network (WLAN) wireless interface, a worldwide interoperability for microwave access (Wi-MAX) interface, an Ethernet interface, a universal serial bus (USB) interface, a cellular network interface, a Bluetooth interface, and a near-field communication (NFC) interface.

In an embodiment of this specification, the foregoing components of the computing device 500 and other components not shown in FIG. 5 may also be connected to each other, for example, by using the bus. It should be understood that the structural block diagram of the computing device shown in FIG. 5 is merely used as an example, but is not intended to limit the scope of this specification. A person skilled in the art may add or replace other components as required.

The computing device 500 may be any type of static or mobile computing devices, including a mobile computer or a mobile computing device (for example, a tablet computer, a personal digital assistant, a laptop computer, a notebook computer, or a netbook), a mobile phone (for example, a smartphone), a wearable computing device (for example, a smart watch or smart glasses), or another type of mobile device, or a static computing device such as a desktop computer or a PC (Personal Computer). The computing device 500 may alternatively be a mobile or static server.

When executing computer instructions, the processor 520 implements steps of the request processing method.

The foregoing is a schematic solution of the computing device in this embodiment. It should be noted that the technical solutions of the computing device and the technical solutions of the foregoing request processing method belong to a same concept. For details that are not described in detail in the technical solutions of the computing device, reference may be made to the descriptions of the technical solutions of the foregoing request processing method.

An embodiment of this specification further provides a request processing system, storing computer instructions. The system includes a service node and a client. The client is configured to store request sending executable instructions. When the request sending executable instructions are executed by the client, steps of the request processing method are implemented, and to enable interaction between the client and the service node.

An embodiment of this specification further provides a computer-readable storage medium, storing computer instructions. When the computer instructions are executed by a processor, steps of the request processing method are implemented.

The foregoing is a schematic solution of the computer-readable storage medium in this embodiment. It should be noted that the technical solutions of the storage medium and the technical solutions of the foregoing request processing method belong to a same concept. For details that are not described in detail in the technical solutions of the storage medium, reference may be made to the descriptions of the technical solutions of the foregoing request processing method.

An embodiment of this specification further provides a computer program. When the computer program is run on a computer, the computer is enabled to perform steps of the request processing method.

The foregoing is a schematic solution of the computer program in this embodiment. It should be noted that the technical solutions of the computer program and the technical solutions of the foregoing request processing method belong to a same concept. For details that are not described in detail in the technical solutions of the computer program, reference may be made to the descriptions of the technical solutions of the foregoing request processing method.

Embodiments of this specification are described above. Other embodiments fall within the scope of the appended claims. In some embodiments, the actions or steps recorded in the claims may be performed in sequences different from those in the embodiments and an expected result may still be achieved. In addition, the processes depicted in the accompanying drawings are not necessarily performed in the specific order or successively to achieve an expected result. In some implementations, multitasking and parallel processing may be feasible or beneficial.

The computer instructions include computer program code, and the computer program code may be in a form of source code, a form of object code, a form of an executable file, some intermediate forms, or the like. The computer-readable storage medium may include any entity or apparatus, a record medium, a USB flash drive, a removable hard disk, a floppy disk, an optical disc, a computer memory, a read-only memory (ROM), a random access memory (RAM), an electric carrier signal, a telecommunication signal, a software distribution medium, and the like that can carry the computer program code. It should be noted that content included in the computer-readable medium may be properly increased or decreased based on requirements of legislation and patent practices in jurisdictions. For example, in some jurisdictions, based on legislation and patent practices, the computer-readable medium does not include the electric carrier signal and the telecommunication signal.

It needs to be noted that, for ease of description, the method embodiments are described as a series of action combinations. However, a person skilled in the art should know that the embodiments of this specification are not limited to the described order of actions, because some steps may be performed in another order or simultaneously according to the embodiments of this specification. In addition, a person skilled in the art should also learn that, the embodiments described in this specification are embodiments, and actions and modules involved are not necessarily all required in the embodiments of this specification.

In the foregoing embodiments, the descriptions of the embodiments have respective focuses. For a part that is not described in detail in an embodiment, reference may be made to related descriptions in other embodiments.

The embodiments of this specification disclosed above are merely used to help explain this specification. Not all details are described in detail in the embodiments, and the embodiments do not limit the present disclosure to only the specific implementations. It is clear that many modifications and variations can be made according to the content of the embodiments of this specification. These embodiments are selected and specifically described in this specification, to better explain the principles and actual application of the embodiments of this specification, so that a person skilled in the art can understand and use this specification well. This specification is limited to only the claims and all the scopes and equivalents thereof.

1. A request processing method, applied to a target client and comprising:
receiving a to-be-sent request for a target service node;
determining request statistical information and load information that correspond to the target service node;
when it is determined, based on the request statistical information and the load information, that the to-be-sent request satisfies a defer-sending condition, determining a deferring policy corresponding to the to-be-sent request; and
sending the to-be-sent request to the target service node according to the deferring policy.

2. The method according to claim 1, wherein the determining request statistical information that corresponds to the target service node comprises:
determining a historical sending request that is for the target service node within a preset time period and historical response information corresponding to the historical sending request; and
determining, based on the historical sending request and the historical response information, the request statistical information that corresponds to the target service node.

3. The method according to claim 2, wherein the determining load information that corresponds to the target service node comprises:
receiving historical reply information of the target service node for the historical sending request; and
determining, based on the historical reply information, the load information that corresponds to the target service node.

4. The method according to claim 2, wherein the determining load information that corresponds to the target service node comprises:
receiving heartbeat information sent by a heartbeat server for the target service node, wherein the heartbeat server is configured to monitor load information corresponding to each service node; and
determining, based on the heartbeat information, the load information that corresponds to the target service node.

5. The method according to claim 2, wherein the when it is determined, based on the request statistical information and the load information, that the to-be-sent request satisfies a defer-sending condition, determining a deferring policy corresponding to the to-be-sent request comprises:
calculating, based on a historical request quantity of historical sending requests and a historical failure quantity of the historical response information, a historical request failure rate of the target service node that is within a preset period;
calculating, based on the load information, a preset deferring threshold corresponding to the to-be-sent request, wherein the preset deferring threshold comprises a preset request quantity and a preset request failure rate; and
when the historical request quantity is greater than the preset request quantity, and the historical request failure rate is greater than the preset request failure rate, determining that the to-be-sent request satisfies the defer-sending condition, and continuing to perform the step of determining the deferring policy corresponding to the to-be-sent request.

6. The method according to claim 1, wherein when the deferring policy is a time deferring policy, the sending the to-be-sent request to the target service node according to the deferring policy comprises:
determining a historical request failure rate based on the time deferring policy, and calculating a deferring duration based on the historical request failure rate; and
sending the to-be-sent request to the target service node based on the deferring duration.

7. The method according to claim 6, wherein the calculating a deferring duration based on the historical request failure rate comprises:
calculating an initial deferring duration based on the historical request failure rate; and
determining a random duration corresponding to the to-be-sent request, and calculating the deferring duration based on the random duration and the initial deferring duration.

8. The method according to claim 6, wherein the sending the to-be-sent request to the target service node based on the deferring duration comprises:
determining a time deferring period based on the time deferring policy, wherein the time deferring period is used to determine an execution period for executing the time deferring policy to send a global request for the target service node; and
sending the to-be-sent request to the target service node based on the deferring duration within the time deferring period.

9. The method according to claim 6, wherein the method further comprises:
determining a request response duration corresponding to the to-be-sent request; and
generating response failure information of the to-be-sent request when the deferring duration is longer than the request response duration.

10. The method according to claim 1, wherein the method further comprises:
counting a target request quantity and a target failure quantity that correspond to the to-be-sent request; and
updating the request statistical information based on the target request quantity and the target failure quantity.

11. A computing device, used in a target client, wherein the computing device comprises a memory, a processor, and computer instructions stored in the memory and executable in the processor, and wherein when the processor executes the computer instructions, the target client is configured to:
receive a to-be-sent request for a target service node;
determine request statistical information and load information that correspond to the target service node;
when it is determined, based on the request statistical information and the load information, that the to-be-sent request satisfies a defer-sending condition, determine a deferring policy corresponding to the to-be-sent request; and
send the to-be-sent request to the target service node according to the deferring policy.

12. A request processing system, wherein the system comprises a service node and a client;
wherein the client is configured to store request sending executable instructions; and when the request sending executable instructions are executed by the client interaction between the client and the service node is enabled, wherein the client is configured to:
receive a to-be-sent request for the service node;
determine request statistical information and load information that correspond to the service node;
when it is determined, based on the request statistical information and the load information, that the to-be-sent request satisfies a defer-sending condition, determine a deferring policy corresponding to the to-be-sent request; and
send the to-be-sent request to the service node according to the deferring policy.

13. (canceled)

14. A non-transitory computer-readable storage medium, storing computer-executable instructions, wherein when the computer-executable instructions are executed by a processor, steps of the method according to claim 1 are implemented.

15. The computing device according to claim 11, wherein the target client is specifically configured to:
determine a historical sending request that is for the target service node within a preset time period and historical response information corresponding to the historical sending request; and
determine, based on the historical sending request and the historical response information, the request statistical information that corresponds to the target service node.

16. The computing device according to claim 15, wherein the target client is specifically configured to:
receive historical reply information of the target service node for the historical sending request; and
determine, based on the historical reply information, the load information that corresponds to the target service node.

17. The computing device according to claim 15, wherein the target client is specifically configured to:
receive heartbeat information sent by a heartbeat server for the target service node, wherein the heartbeat server is configured to monitor load information corresponding to each service node; and
determine, based on the heartbeat information, the load information that corresponds to the target service node.

18. The computing device according to claim 15, wherein the target client is specifically configured to:
calculate, based on a historical request quantity of historical sending requests and a historical failure quantity of the historical response information, a historical request failure rate of the target service node that is within a preset period;
calculate, based on the load information, a preset deferring threshold corresponding to the to-be-sent request, wherein the preset deferring threshold comprises a preset request quantity and a preset request failure rate; and
when the historical request quantity is greater than the preset request quantity, and the historical request failure rate is greater than the preset request failure rate, determine that the to-be-sent request satisfies the defer-sending condition, and continue to perform the step of determining the deferring policy corresponding to the to-be-sent request.

19. The request processing system according to claim 12, wherein the client is specifically configured to:
determine a historical sending request that is for the service node within a preset time period and historical response information corresponding to the historical sending request; and
determine, based on the historical sending request and the historical response information, the request statistical information that corresponds to the service node.

20. The request processing system according to claim 19, wherein the client is specifically configured to:
receive historical reply information of the service node for the historical sending request; and
determine, based on the historical reply information, the load information that corresponds to the service node.

21. The request processing system according to claim 19, wherein the client is specifically configured to:
receive heartbeat information sent by a heartbeat server for the service node, wherein the heartbeat server is configured to monitor load information corresponding to each service node; and determine, based on the heartbeat information, the load information that corresponds to the service node.
